(19) United States
(12) Patent Application Publication
(10) Pub. No.: US 2021/0366044 A1
(43) Pub. Date: Nov. 25, 2021

(54) SYSTEMS AND METHODS FOR MANAGING ALLOCATION OF RESOURCES

(71) Applicant: The Toronto-Dominion Bank, Toronto (CA)

(72) Inventors: Gregory John BALDWIN, Toronto (CA); John SAID, Mississauga (CA); Jay GEDGE, Vaughan (CA)

(73) Assignee: The Toronto-Dominion Bank, Toronto (CA)

(21) Appl. No.: 16/882,633

(22) Filed: May 25, 2020

(51) Int. Cl. G06Q 40/04; G06Q 10/10; G06Q 10/06

(52) U.S. Cl. CPC G06Q 40/04; G06Q 10/06316; G06Q 10/10

(57) ABSTRACT

A processor-implemented method is disclosed. The method includes: receiving, via a client device, a first user input indicating a target allocation for one or more trading accounts, the target allocation identifying an allocation of tradeable objects in the one or more trading accounts; generating a set of trade orders, wherein the generating includes: comparing the target allocation to current holdings of tradeable objects in the one or more trading accounts to identify differences between the target allocation and the current holdings; and generating one or more trade orders based on the identified differences, the trade orders intended to conform the holdings to the target allocation; receiving, via the client device, a second user input requesting a re-allocation of tradeable objects in the one or more trading accounts; in response to receiving the second user input, execute the set of trade orders, wherein the executing includes: determining, for at least one of the trade orders, one or more respective preconditions associated with executing the trade order; executing the trade orders, wherein a given one of the trade orders is executed responsive to the associated preconditions being satisfied.

### TECHNICAL FIELD

The present disclosure relates to computerized systems and, more particularly, to systems and methods for dynamically managing resource allocations and execution of transaction events associated with resource accounts.

### BACKGROUND

Computer systems may be utilized in managing resource accounts containing different types and quantities of resources. For example, a resource server associated with a business entity may control access to account operations and data for resource accounts that are associated with customers of the business entity. A resource account may indicate current holdings of certain resources, or assets, which have specific values. The assets may, for example, include tradeable objects whose perceived or actual values are susceptible to change.

A common feature of resource management systems is facilitating trading activities in connection with resource accounts, which may result in changes in the quantities and/or associated values of the resources. For example, a resource management system may enable resource acquisition (e.g. purchase) activities in connection with one or more of the resources, thereby increasing holdings of those resources in the resource account.

Timely and accurate execution of trades may be essential for optimizing the values of resources in a resource account. The resources may, for example, be traded on various exchanges or marketplaces, and the associated values for those resources may fluctuate quickly due to changing market conditions. In addition, effective resource account management generally requires assessment of account preferences associated with each resource account. Account preferences for a resource account may, for example, include user-defined preferences or control settings relating to resource trading activities (e.g. risk tolerance, etc.), composition or allocation of resources for the account, and specific objectives associated with the account.

It would be advantageous to provide a system for resource management which streamlines trading activities associated with managed resource accounts and that integrates defined account preferences and objectives for the resource accounts.

### BRIEF DESCRIPTION OF THE DRAWINGS

Reference will now be made, by way of example, to the accompanying drawings which show example embodiments of the present application and in which:

FIG. 1 is a schematic operation diagram illustrating an operating environment of an example embodiment;

FIG. 2 is a high-level schematic diagram of an example computing device;

FIG. 3 is a schematic block diagram showing a simplified organization of software components stored in memory of the example computing device of FIG. 2;

FIG. 4 shows, in flowchart form, an example process for managing resource allocation for a resource account;

FIG. 5 shows, in flowchart form, an example method for generating proposed trade orders for a trading account;

FIG. 6 shows, in flowchart form, an example method for executing one or more proposed trade orders generated for a trading account; and

FIG. 7 shows an example graphical user interface of an application for managing trading activities in connection with resources in a resource account.

Like reference numerals are used in the drawings to denote like elements and features.

### DETAILED DESCRIPTION OF EXAMPLE EMBODIMENTS

In an aspect, a computing system is disclosed. The computing system includes a communications module communicable with an external network, a memory, and a processor coupled to the communications module and the memory. The processor is configured to: receive, via a client device, a first user input indicating a target allocation for one or more trading accounts, the target allocation identifying an allocation of tradeable objects in the one or more trading accounts; generate a set of trade orders, wherein the generating includes: comparing the target allocation to current holdings of tradeable objects in the one or more trading accounts to identify differences between the target allocation and the current holdings; and generating one or more trade orders based on the identified differences, the trade orders intended to conform the holdings to the target allocation; receive, via the client device, a second user input requesting a re-allocation of tradeable objects in the one or more trading accounts; in response to receiving the second user input, execute the set of trade orders, wherein the executing includes: determining, for at least one of the trade orders, one or more respective preconditions associated with executing the trade order; executing the trade orders, wherein a given one of the trade orders is executed responsive to the associated preconditions being satisfied.

In some implementations, determining, for at least one of the trade orders, a respective precondition associated with the trade order may include determining an order of execution of the trade order.

In some implementations, determining, for at least one of the trade orders, a respective precondition associated with the trade order may include identifying one or more related trade orders that are required to be executed prior to the trade order.

In some implementations, the processor may be configured to determine, for at least one of the related trade orders, an associated timeout period, and wherein the trade order is executed only upon expiration of the associated timeout period for the at least one of the related trade orders.

In some implementations, the processor may be further configured to determine asset classes associated with the tradeable objects of the current holdings, and wherein identifying differences between the target allocation and the current holdings comprises determining differences for respective ones of the asset classes.

In some implementations, the processor may be further configured to: determine one or more customized allocations based on the current holdings of tradeable objects in the one or more trading accounts; and transmit, for display on the client device, the one or more customized allocations.

In some implementations, generating the set of trade orders may include: identifying one or more tradeable objects indicated in the target allocation which are not included in the current holdings; and generating buy orders corresponding to the identified tradeable objects.

In some implementations, generating the set of trade orders may include: identifying one or more tradeable objects included in the current holdings which are not indicated in the target allocation; and generating sell orders corresponding to the identified tradeable objects.

In some implementations, the processor may be further configured to: detect that one or more of the trade orders cannot be executed as initially generated; in response to the detecting, determine changes to the set of trade orders by identifying one or more additional trade orders; and execute the one or more additional trade orders.

In some implementations, the set of trade orders may not be changed after execution of the trade orders begins.

In another aspect, a computer-implemented method is disclosed. The method includes: receiving, via a client device, a first user input indicating a target allocation for one or more trading accounts, the target allocation identifying an allocation of tradeable objects in the one or more trading accounts; generating a set of trade orders, wherein the generating includes: comparing the target allocation to current holdings of tradeable objects in the one or more trading accounts to identify differences between the target allocation and the current holdings; and generating one or more trade orders based on the identified differences, the trade orders intended to conform the holdings to the target allocation; receiving, via the client device, a second user input requesting a re-allocation of tradeable objects in the one or more trading accounts; in response to receiving the second user input, execute the set of trade orders, wherein the executing includes: determining, for at least one of the trade orders, one or more respective preconditions associated with executing the trade order; executing the trade orders, wherein a given one of the trade orders is executed responsive to the associated preconditions being satisfied.

In yet another aspect, a non-transitory computer readable storage medium is disclosed. The computer readable storage medium contains instructions thereon which, when executed by a processor, configure the processor to: receive, via a client device, a first user input indicating a target allocation for one or more trading accounts, the target allocation identifying an allocation of tradeable objects in the one or more trading accounts; generate a set of trade orders, wherein the generating includes: comparing the target allocation to current holdings of tradeable objects in the one or more trading accounts to identify differences between the target allocation and the current holdings; and generating one or more trade orders based on the identified differences, the trade orders intended to conform the holdings to the target allocation; receive, via the client device, a second user input requesting a re-allocation of tradeable objects in the one or more trading accounts; in response to receiving the second user input, execute the set of trade orders, wherein the executing includes: determining, for at least one of the trade orders, one or more respective preconditions associated with executing the trade order; executing the trade orders, wherein a given one of the trade orders is executed responsive to the associated preconditions being satisfied.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, the term “tradeable object” refers to any object which may be traded. A certain quantity of a tradeable object may be bought or sold for a particular price. A tradeable object may include, without limitation, stocks, options, bonds, future contracts, currency, warrants, derivatives, securities, commodities, swaps, interest rate products, index-based products, goods, or a combination thereof. More generally, a tradeable object may include a product listed and/or administered by an exchange or marketplace, a product defined by an entity, a combination of real and synthetic products, or a combination thereof.

The present application relates to resource account management and, more particularly, to methods for dynamically managing allocation of resources in a resource account. A resource account may specify holdings of various types and quantities of resources (e.g. assets) for an associated entity, such as a business, individual, etc. By way of example, a resource account for a customer of a financial institution, such as a banking institution, may be associated with a bank account and an investment portfolio (and, more generally, a trading account) that is composed of actual positions held by the customer in various securities.

A resource account may have an associated resource (or asset) allocation. A resource allocation refers to the apportioning of an account's resources among a plurality of resources types, or classes. An account's resource allocation may be defined by the entity associated with the account or selected among various predefined allocation profiles. By way of example, a customer of a financial institution may define a target allocation of assets associated with their account, which balances their perceived risk and reward over time. The customer's assets may, for example, be apportioned among different classes of assets, such as equities, fixed income, and cash (and equivalents), based on the customer's defined asset allocation. The asset classes are associated with different levels of risk and return, and so a customer may select different asset allocation profiles depending on their objectives for the account. The choice of an asset allocation profile may depend on several factors such as capital preservation, potential for capital growth, and tolerance for fluctuations in investment value.

Computerized systems are generally employed to administer resource accounts. A computerized system, such as a resource server, may be used for managing account operations, data access control, usage monitoring, etc. associated with one or more managed resource accounts. As a particular example, a resource management system associated with a business entity may enable a customer of the business to define a target allocation for their account with the resource management system. The target allocation may, for example, specify a desired apportionment, or weighting, of the account's resources among a plurality of different classes of assets that may be acquired for the account.

A technical challenge for such a resource management system is the timely and accurate detection of divergence of current allocation data from user-specified target allocations. A resource account may contain different types of resources, and the quantity and/or value of resources associated with the resource account may change quickly and frequently. For example, where a resource account includes a portfolio that includes publicly tradeable securities, the values of the resources of the resource account may change dynamically as a result of market changes. In particular, an account that contains resources whose values change in real-time (e.g. stocks) may undergo fluctuations in resource weightings due to differing returns on the resources. As the customer may not monitor their resource account constantly, they may not notice when a current weight of resources diverges from a defined target allocation, or may act too late to prevent the current weight from deviating from the target allocation.

Another technical challenge for a resource management system is reconciling a re-alignment of resource weightings with current resource accounts data. A resource account may be constantly updated, with the quantity and/or values of the resources changing dynamically. For example, a resource account may be updated as a result of execution of trade orders to acquire or sell certain quantities of resources/assets, or other types of account activities that amount to deposits or withdrawals (e.g. deposits/withdrawals made by other computing systems which have data access privileges) for the resource account. For a resource account that has a significant number of activities, speed of account operations, such as purchase or sale of resources in connection with the account, is crucial for re-aligning the resource weightings for the account; otherwise, the volume of activities associated with the account can quickly result in major shifts in current allocation away from a defined target allocation.

A resource management system that enables resource trading activities may be presented with yet further technical challenges. A system that facilitates resource trading and management may be complicated for a typical user to navigate. In particular, users may find it difficult to both manage the resources (which may include tradeable objects) of their resource accounts while also engaging in trading activities in connection with those resources. For example, monitoring account details of a resource account, such as checking balance information, account composition, etc., may be done through conventional processes for account management. To engage in trading in connection with the resources associated with the account, a user may need to access a separate trade-order interface that enables the user to specify parameters required to complete the purchase or sale of certain quantities of their resources. The trade parameters may be manually input by the user, for example, in a user interface for a digital trading portal, separately from a user interface for an account management system. This process is cumbersome and time-consuming, and may lead to undesirable outcomes. For example, where the values (e.g. price) of the tradeable resources are subject to fluctuate according to rapidly changing market conditions, the time required to switch user interfaces and manually input parameters for trading may impact the ability to trade at desired resource values.

The present application proposes technical solutions to the aforementioned challenges for a resource management system. In an aspect, the present application discloses a system that dynamically manages allocation of resources for resource accounts. More particularly, a system that is configured to automatically perform re-balancing of resources is disclosed. The system receives user input of a target allocation, or weighting, of tradeable objects in one or more trading accounts. The system automatically generates a set of proposed trade orders for execution, based on comparing the target allocation to current holdings of tradeable objects in the trading accounts and identifying differences. The proposed trade orders are generated based on the identified differences such that their execution is intended to conform the holdings to the target allocation. Upon receiving a further user input requesting re-allocation (i.e. re-alignment) for the trading accounts, the system causes the set of proposed trade orders to be executed. In particular, the system determines, for at least one of the proposed trade orders, one or more respective preconditions associated with executing the trade order, and executes the trade order responsive to the associated preconditions being satisfied.

In another aspect, the present application discloses a platform for facilitating electronic trading. More particularly, a system that is configured to generate proposed trade orders for re-balancing resource accounts is described. The proposed trade orders are generated based on identifying differences between a defined target allocation for one or more trading accounts and current holdings of tradeable objects in the trading accounts. Upon receipt of a user input requesting re-allocation (i.e. re-aligning the weightings of assets) for the trading accounts, the system causes the proposed trade orders to be executed. The proposed trade orders are executed, responsive to the preconditions associated with the trade orders being satisfied.

In yet a further aspect, the present application discloses a user interface for a resource account management system. The user interface may allow for concurrently managing resources of a resource account and engaging in trading in connection with said resources of the account.

In at least some embodiments, the user interface may provide a digital shopping cart for maintaining a current set of proposed trade orders for a resource account. More particularly, a digital shopping cart (or similar data structure) may be used to track a current set of proposed trade orders that are designed to conform the resource account to a target allocation. The digital shopping cart may function in a similar manner as, for example, an electronic commerce (e-commerce) shopping cart, allowing for one or more trade orders to be integrated into the digital shopping cart. The trade orders of the digital shopping cart may be executed responsive to a user instruction. For example, a user may cause a current set of proposed trade orders of the digital shopping cart to be executed by actuating a defined user interface element associated with a graphical user interface for the resource account management system.

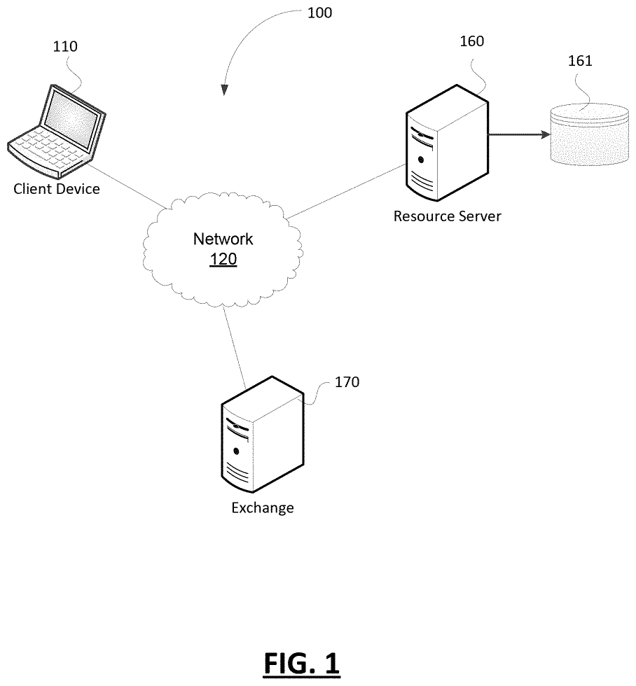

FIG. 1 illustrates an exemplary computing environment 100 consistent with certain disclosed embodiments. As shown in FIG. 1, the computing environment 100 may include one or more client devices 110, a resource server 160, a database 161 associated with the resource server 160, an exchange 170, and a communications network 120 connecting one or more of the components of environment 100.

As illustrated, a resource server 160 (which may also be referred to as a server computer system) and client device 110 communicate via the network 120. In at least some embodiments, the client device 110 is a computing device. The client device 110 may take a variety of forms including, for example, a mobile communication device such as a smartphone, a tablet computer, a wearable computer such as a head-mounted display or smartwatch, a laptop or desktop computer, or a computing device of another type. The client device 110 is associated with a client entity (e.g. an individual, an organization, etc.) having resources that are managed by or using the resource server 160. For example, the resource server 160 may be a financial institution server and the client entity may be a customer of a financial institution operating the financial institution server. The client device 110 may store software instructions that cause the client device to establish communications with the resource server 160 and, in some embodiments, one or more exchanges 170 that are associated with markets (e.g. stock market, foreign exchange market, etc.).

The resource server 160 may track, manage, and maintain resources, make lending decisions, and/or lend resources to a client entity associated with the client device 110. The resources may, for example, be computing resources, such as memory or processor cycles. In at least some embodiments, the resources may include stored value, such as fiat currency, which may be represented in a database. For example, the resource server 160 may be coupled to a database 161, which may be provided in secure storage. The secure storage may be provided internally within the resource server 160 or externally. The secure storage may, for example, be provided remotely from the resource server 160. For example, the secure storage may include one or more data centers. The data centers may, for example, store data with bank-grade security.

The database 161 may include records for a plurality of accounts and at least some of the records may define a quantity of resources associated with the client entity. For example, the client entity may be associated with an account having one or more records in the database 161. The records may reflect a quantity of stored resources that are associated with the client entity. Such resources may include owned resources and, in at least some embodiments, borrowed resources (e.g. resources available on credit). The quantity of resources that are available to or associated with the client entity may be reflected by a balance defined in an associated record such as, for example, a bank balance.

In at least some embodiments, the database 161 may store various types of information in connection with customers of a business entity that administers the resource server 160. For example, the database 161 may store customer profile data and financial account data associated with customers. The customer profile data may include, without limitation, personal information of registered customers, authentication credentials of the customers, account identifying information (e.g. checking account, savings account, revolving credit line, etc.), and information identifying services (e.g. banking services, investment management services, etc.) and/or programs that are offered to the customers by the business entity. The financial account data may include portfolio data relating to portfolios of investments that are held by customers. A customer's portfolio data may include, for example, information identifying actual positions held by the customer in various securities, information identifying a “virtual” portfolio composed of simulated positions held by the customer in various securities, and “watch lists” specifying various securities that are monitored by the customer.

The business entity associated with the resource server 160 may provide services that are accessible to the client entity. For example, the business entity may provide account management services, financial transaction services, and investment management services for the client entity. In at least some embodiments, the resource server 160 may be configured to provide a user interface that allows client devices 110 to access the services offered by the business entity. By way of example, the resource server 160 may be configured to provide a website or web-based portal which can be accessed via the client devices 110. The website (or portal) may include web content corresponding to various services offered by the business entity, and the resource server 160 may provide the web content for display on the client devices 110. As another example, the resource server 160 may be associated with a software application which may be installed and/or run on the client devices 110. In some embodiments, the resource server 160 may be a backend server for an application (e.g. mobile app, web application, etc.) which may be accessed on the client device 110. The application may, for example, be a mobile banking or investment management application. A graphical user interface (GUI) associated with the application may present the content corresponding to the services offered by the business entity on a display associated with the client device 110. A customer may interact with the business entity and its service offerings via the GUI of the application.

The computing environment 100 also includes an exchange 170. The exchange 170 may be owned, operated, controlled, or used by an exchange entity. The exchange 170 represents a trading platform in which order entry and forwarding, matching of buy and sell orders, and price determination may be performed by a computerized system. In at least some embodiments, the exchange 170 may be an electronic exchange. Orders for tradeable objects (e.g. financial products offered for trading by an exchange) can be placed using the exchange 170. In particular, the exchange 170 may be adapted to receive order messages and match contra-side trade orders to buy and sell tradeable objects.

The resource server 160 is in communication with the exchange 170. In some embodiments, the resource server 160 may be in communication with a gateway that, in turn, is in communication with the exchange 170. The resource server 160 is configured to send instructions to the exchange 170. In particular, the resource server 160 may generate order messages that include trade orders and transmit the order messages to the exchange 170. A trade order may, for example, be a command to place an order to buy or sell a tradeable object, a command to modify or cancel an order, or a combination thereof.

The resource server 160 may generate order messages at the request of an entity, such as a user of client device 110. For example, the user may manually input one or more parameters of a trade order (e.g. order price, quantity, etc.) via the client device 110, and request the resource server 160 to execute the trade order on her behalf. Additionally, or alternatively, the resource server 160 may generate order messages based on trade orders that are automatically generated at the resource server 160. In particular, order messages for transmitting to the exchange 170 may be generated based on trade orders which are automatically generated by the resource server in accordance with various embodiments of the methods disclosed in the present application.

The exchange 170 may additionally be adapted to provide market data. For example, the exchange 170 may publish a data feed to subscribing entities, which may include the client devices 110 and/or the resource server 160.

The client device 110, the resource server 160, and the exchange 170 may be in geographically disparate locations. Put differently, the client device 110 may be remote from one or both of the resource server 160 and the exchange 170. As described above, the client device 110, the resource server 160, and the exchange 170 may be computer systems.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

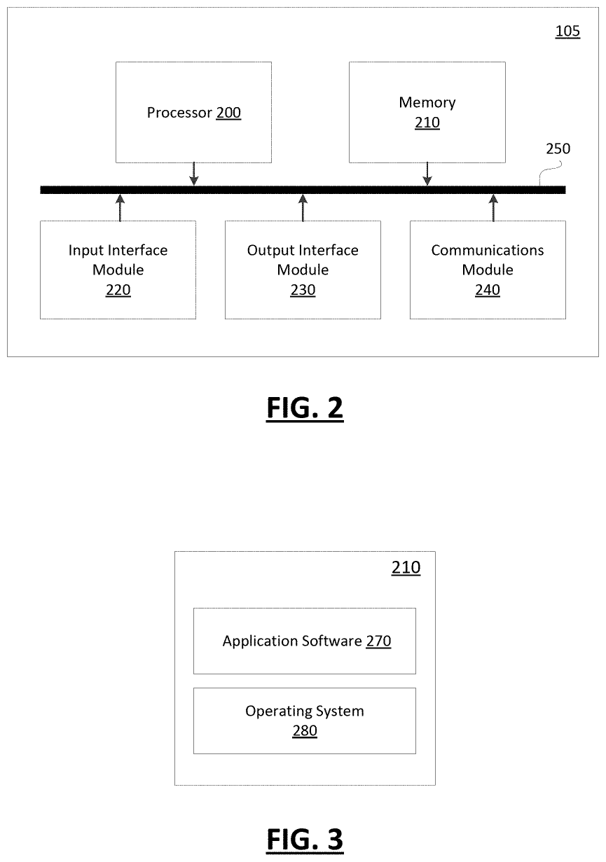

FIG. 2 is a high-level operation diagram of an example computing device 105. In some embodiments, the example computing device 105 may be exemplary of one or more of the client device 110, the resource server 160, and the exchange 170. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like.

Additionally or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 3 depicts a simplified organization of software components stored in memory 210 of the example computing device 105. As illustrated these software components include an operating system 280 and application software 270.

The operating system 280 is software. The operating system 280 allows the application software 270 to access the processor 200, the memory 210, the input interface module 220, the output interface module 230 and the communications module 240. The operating system 280 may be, for example, Apple iOS™, Google™ Android™, Linux™, Microsoft™ Windows™, or the like.

The application software 270 adapts the example computing device 105, in combination with the operating system 280, to operate as a device performing a particular function. The application software 270 may, for example, include a mobile banking application. A mobile banking application may be used for performing various personal and business banking activities. For example, a mobile banking application may allow users to access their account data, update or modify account details, pay bills, send money transfers, and deposit cheques.

A mobile banking application may also allow users to purchase and sign up for additional financial services, such as banking, insurance, or investment management services, which may be offered by a bank institution. For example, a mobile banking application may provide a functionality for managing an investment portfolio that contains various securities, such as stocks, bonds, etc. A user's account with a bank institution may include both banking accounts (i.e. for personal or business banking) and trading accounts. In at least some embodiments, a user's banking accounts may be linked with their trading accounts. Once the banking and trading accounts are linked, the funds for buy order transactions may be withdrawn from one or more designated banking accounts, and the proceeds from sell order transactions may be deposited into one or more designated banking accounts. The mobile banking application may allow users to perform various actions relating to portfolio management including, but not limited to, linking banking accounts, defining parameters of trade orders, accessing market data, and monitoring watch lists of securities.

The mobile banking application may be a stand-alone application, such as a mobile app, or integrated into another application or software module resident on the example computing device 105 as a sub-function or feature. The mobile banking application is associated with a backend application server. In at least some embodiments, a server which manages resource accounts associated with the customers of a business entity, such as resource server 160 of FIG. 1, may also serve as the backend application server for the mobile banking application. In particular, various functions of the mobile banking application may be provided, at least in part, by a resource server associated with a bank institution. That is, the resource server may perform backend services of the mobile banking application.

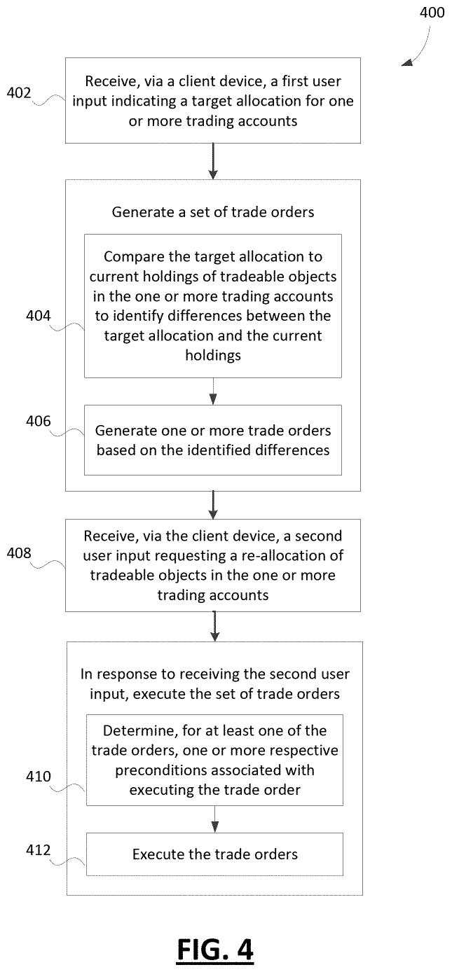

The present disclosure provides systems and methods that address the above-described technical challenges associated with resource management systems. Reference is made to FIG. 4, which shows, in flowchart form, an example process 400 for managing resource allocation for one or more resource accounts. In at least some embodiments, the process 400 may be implemented for re-balancing an allocation of resources, or assets, associated with a resource account, such that the resource allocation can be made to conform to a defined target allocation. As a specific and non-limiting example, the process 400 may be implemented for re-balancing a portfolio associated with a trading account to re-align the weightings of the portfolio to a target asset allocation.

Operations 402 and onward may be performed by one or more processors of a computing device such as, for example, the processor 200 (FIG. 2) of one or more suitably configured instances of the example computing device 105 (FIG. 2). In at least some embodiments, the process 400 may be performed by a server system. In particular, a server (such as the resource server 160 of FIG. 1, in some embodiments) which manages a plurality of resource accounts, may perform all of part of the operations of process 400. For example, a resource server associated with a business entity may implement the process 400 as part of a process for managing the resource accounts associated with customers of the business entity.

In operation 402, the server receives, via a client device, a first user input indicating a target allocation for one or more trading accounts. A target allocation for an account, such as a resource or trading account, represents a definition of an allocation of resources for the account. The target allocation identifies an allocation of tradeable objects in the trading account. In particular, a target allocation for a trading account may define an apportionment of the tradeable objects in the trading account among different types, or classes, of objects. The target allocation may thus describe a target, or desired, composition of a trading account in terms of classes of tradeable objects.

A trading account may be associated with a portfolio of tradeable objects, such as an investment portfolio that defines holdings of various assets (e.g. securities). A target allocation for the trading account may define an asset allocation, or asset “mix”, for the portfolio. The target allocation may indicate how the assets of the portfolio are distributed among different classes of securities, such as stocks, bonds, and cash (and equivalents). For example, a target allocation may specify, for each of one or more asset classes, a target weight that represents a desired weighting for the asset class in the portfolio. A target weight may, in some embodiments, be indicated as a percentage. For example, the target weight may be expressed as a percentage value, representing a percentage of a total current value (e.g. monetary) amount associated with the assets in the portfolio. In some embodiments, a target allocation may additionally specify, for each asset class, a tolerance range. That is, a tolerance level for each asset class' weighting in the portfolio may be indicated by the target allocation.

The target allocation may be defined by a user of the client device. In at least some embodiments, the target allocation may be defined via a user interface associated with a service for managing a trading account. For example, a banking or investment management application may provide a functionality for managing a trading account, and a graphical user interface associated with the application (e.g. mobile app, web application, website, etc.) may allow users to input a target allocation for the trading account.

A trading account may contain different classes of tradeable objects. The owner of the trading account may manually input a target apportionment of the tradeable objects in the trading account among the different classes. That is, the owner may specify a composition of the trading account in terms of the classes of the tradeable objects. Using their device, the owner may input target weights associated with each of one or more of the classes. In some embodiments, the owner may be prompted, on their device, to input values of target weights for the classes of tradeable objects in the trading account. For example, the server may determine the classes of tradeable objects that are included in the trading account (e.g. in a portfolio of the trading account), and provide, to the user's device, a prompt to input target weights corresponding to the classes. The target weights may, for example, be indicated in percentage values. In this way, the target allocation may be customized for the owner of the trading account to include a mapping between classes of tradeable objects in the trading account and target weights assigned by the owner to the classes.

In some embodiments, the target allocation may be selected from a plurality of allocation profiles. The owner of a trading account may select one of the allocation profiles and set it as the target allocation. By way of example, a graphical user interface for an investment management (or banking) application may present a set of allocation profiles for a trading account. The allocation profiles may define different sets of weightings for the tradeable objects in the trading account. In particular, the server may first identify the tradeable objects (or classes thereof) in the trading account, and determine which allocation profiles to present as options based on the identified tradeable objects/classes. For example, if the server determines that a portfolio associated with the trading account contains a mix of stocks, bonds, and cash (and equivalents), the server may obtain a set of allocation profiles that define weightings for stocks, bonds, and cash (and equivalents), respectively. The allocation profiles may be generated by the server upon identifying the tradeable objects in the trading account, or they may be obtained from a set of pre-defined template profiles. A selection of an allocation profile may be input via a client device (for example, by an owner of the trading account) and communicated to the server.

Once the target allocation for a trading account has been obtained, the server generates a set of trade orders that are designed to re-balance the trading account. As a non-limiting example, a set of trade orders for buying or selling assets in a portfolio associated with the trading account are generated by the server. These trade orders, when executed, may allow an original or desired level of asset allocation to be maintained for the portfolio.

In operation 404, the server compares the target allocation to current holdings of tradeable objects in the one or more trading accounts, to identify differences between the target allocation and the current holdings. The current holdings data for a trading account includes various information relating to the tradeable objects that are held in the trading account (e.g. in a portfolio associated with the trading account). For example, the current holdings data may indicate, for each of one or more of the tradeable objects, identifying information for the object, quantity of the object held in the trading account, length of time the object has been held, and class of the object (e.g. asset class). The current holdings data may also indicate, for each class of tradeable object, a corresponding weight of the class. For example, a portfolio associated with a trading account may indicate current holdings of different asset classes, such as stocks, bonds, and cash (and equivalents), and the weightings associated with those asset classes. A weighting for an asset class may, for example, represent the asset class' weight, or percentage, of the portfolio's total current value (e.g. monetary) amount. In some embodiments, the asset class' weight may be determined as a ratio of the value amount of the assets in the portfolio that belong to the asset class against the total current value amount of all assets in the portfolio.

In operation 406, the server generates one or more proposed trade orders based on the identified differences, where the proposed trade orders are intended to conform the current holdings to the target allocation. A proposed trade order may be an order to increase holding in certain tradeable objects, or it may be an order to reduce holding in certain tradeable objects. For example, a proposed trade order may be an order to purchase (or sell) shares of a stock, convertible bonds, etc. Upon comparing the current holdings data with the target allocation for the trading account, the server may be configured to automatically detect any differences.

For example, the server may determine that the current weights of the object classes in the trading account are different from the weightings (i.e. target weights) indicated in the target allocation. That is, the weights of the object classes for the current holdings of tradeable objects may differ from the target weights of those object classes. In some embodiments, a current weight of an object class may be determined to be different from a corresponding target weight if the difference between the two quantities is greater than a predefined threshold. For example, an object class, such as an asset class in an investment portfolio, may have a defined threshold value (or tolerance level). If the difference between a current weight of the object class and the class' target weight exceeds the threshold value, the server may determine that there is an appreciable difference between the quantities and that the weight of the object class should be changed to the target weight.

Depending on the type of the difference between an object class' current weight and target weight, the server may generate either a “buy” trade order or a “sell” trade order. If the server determines that an object class' current weight is less than the target weight (i.e. the current holdings in the object class are underweight), one or more “buy” trade orders may be generated. For example, the server may generate orders to purchase certain quantities of tradeable objects of a class that is underweight relative to the target allocation. If the server determines that an object class' current weight is greater than the target weight (i.e. the current holdings in the object class are overweight), one or more “sell” trade orders may be generated. For example, the server may generate orders to sell certain quantities of tradeable objects of a class that is overweight relative to the target allocation.

In some embodiments, the proposed trade orders for changing the current holdings of tradeable objects of a certain class may be generated such that quantities of the currently held tradeable objects may be increased (or decreased) pro rata to match the target weight of the class. If an object class is determined to be underweight, the server may generate proposed trade orders to purchase quantities of the tradeable objects in accordance with the ratio (“current ratio”) of those tradeable objects as they are currently held in the trading account. For example, if three different stocks (stocks A, B and C) are currently held in the trading account and the “stocks” asset class is determined to be underweight relative to a target allocation, the server may generate proposed trade orders to increase holdings in the stocks A, B and C while keeping the ratio as between the values (i.e. total monetary value) of the three stocks constant. As another example, the server may generate proposed trade orders that increase holdings in the stocks A, B and C while keeping the ratio as between the quantities (e.g. number of shares) of the three stocks constant.

Similarly, if an object class is determined to be overweight relative to a target allocation, the server may generate trade orders to sell quantities of currently held tradeable objects while maintaining the current ratio as between the values (or quantities, etc.) of those tradeable objects held in the trading account constant.

In some embodiments, the choice and quantity of tradeable objects to purchase or sell may be determined based on defined trading preferences associated with the trading account. An owner of a trading account may define various trading preferences or parameters for the trading account. For example, an owner may input, via a user interface associated with an application for managing the trading account (e.g. mobile banking app, investment manager application, etc.), a definition of the owner's preferences in connection with automatically generated trade orders. In some embodiments, the owner may provide a list (a “watch list”) of specific tradeable objects that the owner prefers to acquire and/or would like to monitor for the trading account. For example, the owner may input a list containing identifiers (e.g. ticker symbol, etc.) of tradeable objects that may be included in a watch list. A watch list may include those tradeable objects which are already included in the trading account.

More generally, each tradeable object that is currently included in the trading account and/or a watch list may be associated with a respective preference value, and the tradeable objects may be ranked (i.e. a preference ranking) based on their preference values. In some embodiments, a preference value of a tradeable object may be based, at least in part, on a market performance of that tradeable object. For example, a stock that performs well over a specific period of time may be associated with a high preference value, whereas a stock that performs poorly over the time period may be associated with a low preference value. The server may be configured to dynamically update a preference ranking of the tradeable objects that are included in the trading account and/or any watch lists associated with the trading account.

When the server detects differences between the current holdings of tradeable objects and the target allocation for the trading account, the server may automatically generate trade orders to purchase or sell quantities of tradeable objects based on the preference ranking. For example, if the server determines that a certain class of objects (e.g. assets) is underweight, the server may automatically generate one or more trade orders to purchase tradeable objects having the highest preference ranking. Similarly, if the server determines that a certain class of objects is overweight, the server may automatically generate one or more trade orders to sell those tradeable objects in the trading account that have the lowest preference ranking.

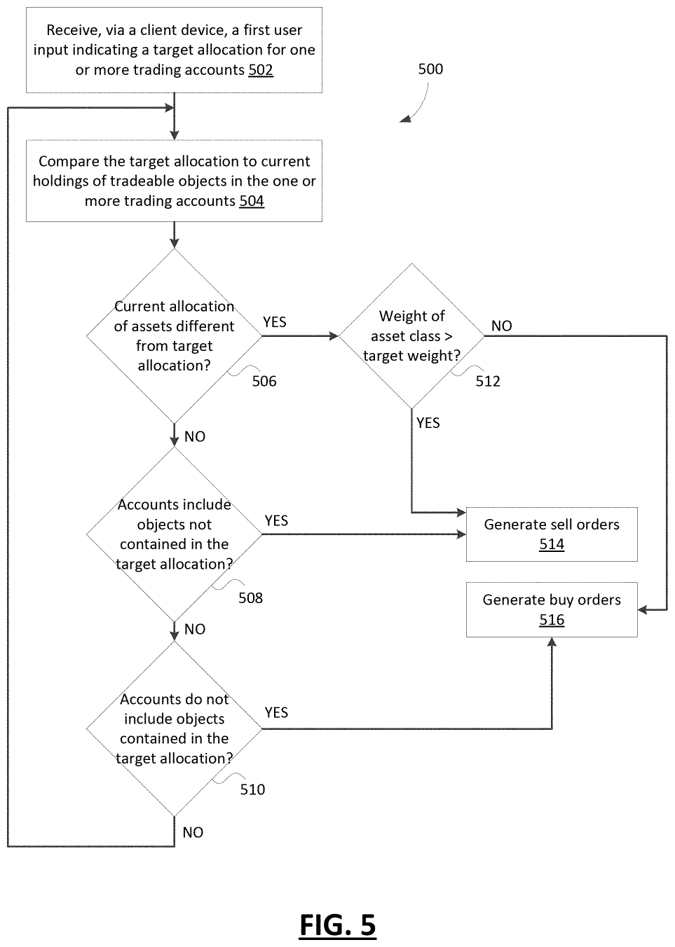

FIG. 5 shows, in flowchart form, an example method 500 for generating proposed trade orders for a trading account. The method 500 may be performed as a sub-method of process 400. In particular, a server that manages resource allocation for a resource account in accordance with process 400 may implement the method 500 when generating proposed trade orders for re-balancing (i.e. re-aligning the weightings of objects in) the resource account. The operations of method 500 may be performed in addition to, or as alternatives, to one or more of the operations of method 400.

The server receives, via a client device, a first user input indicating a target allocation for one or more trading accounts, in operation 502. Upon comparing the current holdings of tradeable objects in a trading account with a defined target allocation for that account (operation 504), the server determines whether there are any differences, in operation 506. In particular, the server may determine whether the current weights associated with object classes of the tradeable objects in the trading account are different from the corresponding target weights for those classes. If a difference between the current weight and the target weight is detected for an object class, the server determines whether the current holdings are underweight or overweight relative to the target allocation, in operation 512. If the current weight is less than the target weight, the server generates one or more “buy” trade orders, in operation 516. If, on the other hand, the current weight is greater than the target weight, the server generates one or more “sell” trade orders, in operation 514. The generation of the proposed trade orders (i.e. “buy” and “sell” trade orders) may proceed as in operation 406 of method 400 described above.

In some embodiments, a target allocation for a trading account may specify certain tradeable objects which are desired to be included in the trading account (for example, in a portfolio associated with the trading account). For example, a target allocation may indicate certain classes of tradeable objects that an owner of the trading account desires to be included. As another example, a target allocation may indicate specific tradeable objects (e.g. specific stocks, bonds, etc.) that should be included in the trading account. Even where the current weights of assets in the trading account do not differ from the corresponding weights defined in a target allocation for the trading account, the server may generate proposed trade orders if it is detected that there are differences in the current holdings from the target allocation. That is, the server may detect differences between the current holdings in the trading account and the target allocation other than differences in object class weightings. In particular, if the server detects that the trading account includes tradeable objects that are not contained in the target allocation (operation 508), the server may generate proposed “sell” orders (operation 514). The “sell” orders correspond to orders to reduce the holdings of those tradeable objects that are not in the target allocation. Similarly, if the server detects that the trading account does not include tradeable objects that are contained in the target allocation in operation 510, the server may generate proposed “buy” orders (operation 516). The “buy” orders correspond to orders to increase the holdings of those tradeable objects that are included in the target allocation. These proposed trade orders to increase (or reduce) the holdings of tradeable objects that are included (or not included) in the target allocation may be generated such that the weightings of the object classes are maintained at the target weights.

Returning to FIG. 4, in operation 408, the server receives, via the client device, a second user input requesting a re-allocation of tradeable objects in the one or more trading accounts. The second user input represents a request (for example, by an owner of a trading account) to re-balance the trading account. In particular, the second user input may be used for initiating a request to align a trading account with a defined target allocation. As an example, an owner of a trading account may communicate a request, via the second user input, to re-balance a portfolio associated with the trading account such that the weights of asset classes of the portfolio are aligned to the target weights for those classes.

According to embodiments of the present disclosure, a server that manages a plurality of resource accounts (e.g. trading accounts) may perform actions dynamically in order to maintain a composition of the resource accounts close to or aligned with a defined target allocation. As described above, a server may compare, on a continual basis, current holdings data for one or more trading accounts and identify differences between said data and a user-selected target allocation. The server may generate proposed trade orders based on the identified differences in the allocation (i.e. account or portfolio composition) data. These actions of comparing the current holdings data with a target allocation, identifying differences therebetween, and generating proposed trade orders for reconciling the identified differences may be performed by the server in the background. That is, the server may perform these actions on an ongoing basis. In particular, a set of proposed trade orders may be generated and constantly updated by the server as the trading accounts (and associated portfolios) undergo changes, such as fluctuations in values due to differing returns among the various tradeable objects in the trading account.

A current set of proposed trade orders for a trading account may be executed only if a user input (i.e. the second user input received in operation 408) is received by the server. In at least some embodiments, the server may maintain a digital resource (e.g. software, service, data storage, etc.) for tracking information about the current set of proposed trade orders. By way of example, the server may maintain a virtual container (or other data structures, and the like) that includes identifying information for an up-to-date set of proposed trade orders for the trading account. The virtual container may, for example, be a digital shopping cart. The digital shopping cart may be structured in a similar manner as an e-commerce shopping cart. In particular, one or more trade orders that are automatically generated by the server may be maintained using, or integrated into, the digital shopping cart.

The server may update the contents of the virtual container such that the proposed trade orders that are included in the virtual container are those which are designed to conform the current holdings of the trading account with the target allocation. In particular, the current set of trade orders represents a set of trade actions that can align an allocation of tradeable objects in the trading account to a defined target allocation. For example, a digital shopping cart may be updated dynamically to reflect the current, or up-to-date, set of proposed trade orders that are automatically generated by the server for conforming a trading account to a target allocation.

In response to receiving the second user input, the server executes the set of trade orders generated in operation 406. More specifically, upon receiving the second user input, the server may cause a current set of proposed trade orders to be executed. As described above, in some embodiments, the current set of proposed trade orders may be maintained using a data structure, such as a virtual container. In this case, the server may determine the current set of proposed trade orders by obtaining the contents of the virtual container. The second user input is the input which triggers execution of the current set of proposed trade orders. In some embodiments, the set of trade orders may be fixed once execution of the trade orders is initiated. That is, when the re-balancing process is initiated, the current set of proposed trade orders may be fixed and cannot be edited to add, remove, modify, change quantity of, etc. trade orders.

The server controls the execution of the proposed trade orders and determines when each of the proposed trade orders is to be executed. In operation 410, the server determines, for at least one of the trade orders, one or more respective preconditions associated with executing the trade order. In at least some embodiments, the server may determine an order of execution of the proposed trade orders. That is, the server may determine, for each proposed trade order, an order in which that trade order is to be executed. For example, the server may identify a ranking of the proposed trade orders and an order of execution of the proposed trade orders may mirror said ranking. The ranking may be based on, for example, trading preference, market performance (e.g. of stocks, bonds, etc.), available quantities of the tradeable objects, etc. In some cases, two or more trade orders may be placed in tandem and allowed to execute simultaneously. For example, a plurality of “sell” trade orders may be placed in tandem.

In some embodiments, the server may identify, for each proposed trade order, one or more related trade orders that are required to be executed prior to the proposed trade order. For example, execution of a proposed trade order may await completion of one or more related trade orders. As a particular example, execution of a particular “buy” trade order may await completion of one or more “sell” orders due to a lack of resources in the trading account.

In operation 412, the server causes execution of the trade orders. A trade order is executed responsive to the preconditions associated with the trade order being satisfied. The server may generate order messages corresponding to the proposed trade orders whose associated preconditions have been satisfied, and the order messages may be transmitted to suitable exchanges (e.g. electronic exchange). In some embodiments, user confirmation may be required before any order message is submitted to an exchange. For example, the server may prompt the user for confirmation prior to sending order messages, either individually or in batches, to their respective exchanges. The order messages may be submitted to the exchanges only if confirmation input is received from the user, for example, via their client device.

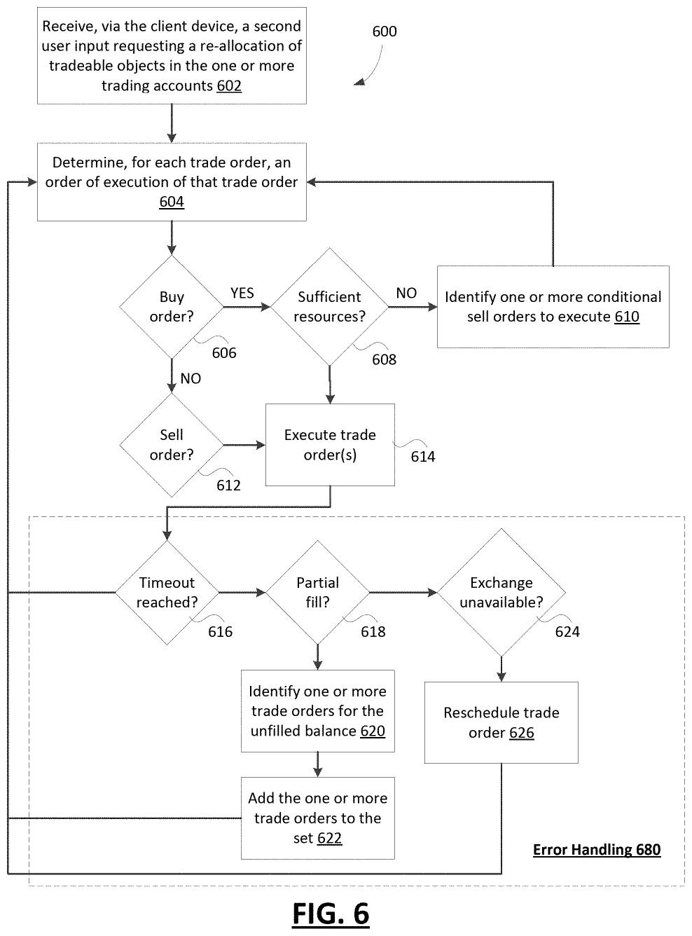

FIG. 6 shows, in flowchart form, an example method 600 for executing one or more proposed trade orders for a trading account. The method 600 may be performed as a sub-method of process 400 of FIG. 4. In particular, a server that manages resource allocation for a resource account in accordance with process 400 may implement the method 600 when executing one or more proposed trade orders that have been generated for re-balancing (i.e. re-aligning the weightings of objects in) the resource account.

Upon receiving the second user input requesting re-balancing/re-allocation (operation 602), the server determines, for each proposed trade order, an order of execution of that trade order in operation 604. The execution of the proposed trade orders may then proceed in accordance with the determined order. If a proposed trade order is determined to be a “buy” trade order in operation 606, the server determines whether there are sufficient resources for funding the purchase associated with the “buy” trade order (operation 608). For example, if a trading account (or banking account and, more generally, a resource account) does not hold sufficient spending power to fund the “buy” trade order, the server proceeds to identify one or more conditional “sell” trade orders among the proposed set of trade orders for execution (operation 610). It will be noted that, because a given “sell” trade order may take some time to be filled, it may not be desirable to simply have all “buy” trade orders await all “sell” trade orders completion. Accordingly, in some embodiments, “sell” trade orders may be executed conditional on sufficient spending power in the trading account. If, on the other hand, the trading account does hold sufficient spending power, the proposed trade order is caused to be executed, in operation 614.

If a proposed trade order is determined to be a “sell” order in operation 612, the server causes, or attempts to cause, execution of said proposed trade order, in operation 614. For example, an order message containing instructions to sell a specific quantity of a security may be generated and transmitted to a relevant exchange for execution.

As illustrated in FIG. 6, trade order execution may involve handling errors or unexpected outcomes. By way of example, if a “sell” trade order is a market order, it could fill at a different price than expected, potentially yielding less (or more) proceeds than expected. This may mean that one or more “buy” trade orders cannot execute (or that one or more “buy” trade orders can be executed without waiting on “sell” trade orders, the proceeds of which might otherwise be required to fund those “buy” trade orders). As another example, a “buy” or “sell” trade order may only receive a partial fill and, potentially, further orders for the unfilled balance may need to be added to the set of proposed trade orders. As yet another example, trade orders may not be able to execute due to one or more exchanges being closed and may need to await opening of trading.

The server may perform the error handling operations 680 while managing execution of the current set of proposed trade orders. For example, the server may check for timeout periods associated with the trade orders (operation 616). That is, the server may determine, for one or more of the proposed trade orders, an associated timeout period. A trade order may be “killed”, or cancelled, upon the expiry of the associated timeout period. Where execution of the trade orders proceeds according to a defined order, trade orders may not be executed until at least the expiry of the timeout periods associated with the preceding trade orders in the defined order.

If the server determines that a proposed trade order is only partially filled (operation 618), the server identifies one or more trade orders for the unfilled balance (operation 620) and adds the identified trade orders to the current set of proposed trade orders (operation 622). The server may additionally perform a check whether a required exchange for a proposed trade order is currently unavailable, in operation 624. For example, an order scheduled for immediate execution may, if the required exchange is closed (and after-hours trading is not available or is not used), be rescheduled to execute during trading hours for that exchange. More generally, responsive to errors, edits may be made to the current set of proposed trade orders and/or order of execution of the proposed trade orders dynamically.

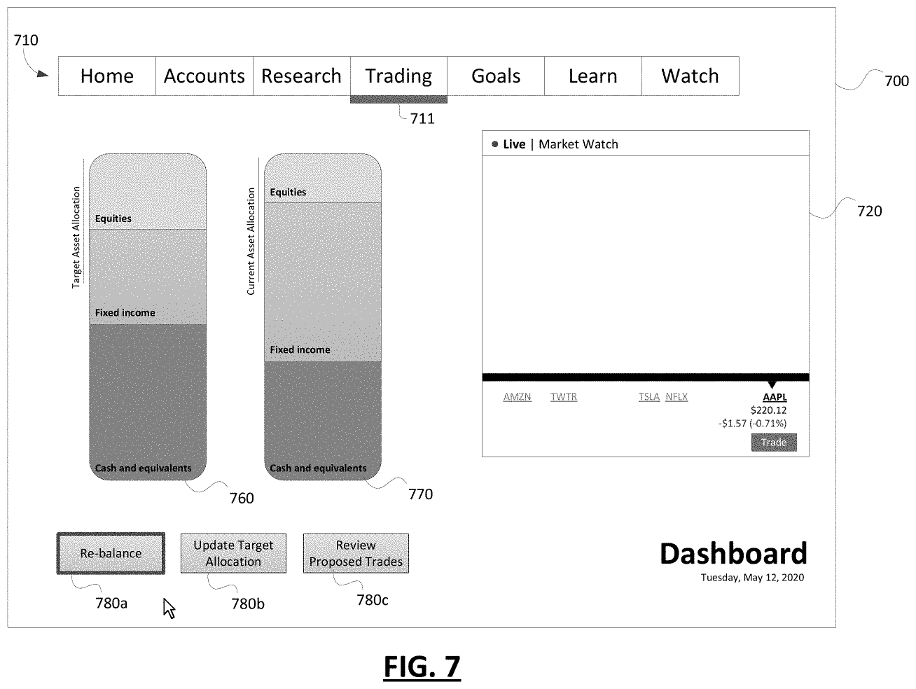

FIG. 7 shows an example user interface 700 for a resource management application which may, in some embodiments, be as a banking application. The user interface 700 may allow users to perform various actions relating to management of their resources, such as financial resources (e.g. cash, investments, etc.). the user interface 700 includes a navigation bar 710 and a plurality of user interface elements 711 corresponding to different pages of the user interface 700. A “Trading” page of the user interface is shown in FIG. 7. The “Trading” page may provide a summary of a user's investment portfolio that is associated with their resource account. As shown in FIG. 7, the “Trading” page may display an investment “dashboard” for the user. From the dashboard, the user may view detailed summary information for their investments, consume media content relating to various tradeable objects (e.g. stock market data), and make adjustments to their investment portfolio.

The “Trading” page, as well as other pages of the user interface 700, may include media content. A video playback interface 720 is shown in FIG. 7. This video playback interface 720 may play videos that are available on the resource management application. For example, videos that are selected by users via the user interface 700 may be shown in the video playback interface 720. Additionally, or alternatively, videos may be selected automatically and begin playing in the video playback interface 720 when a user lands on the “Trading” (or another) page of the user interface 700.

The “Trading” page presents graphical display of resource allocation data for the resource account. More specifically, asset allocation data for a portfolio that is associated with the resource account is provided on the page. FIG. 7 shows user interface elements that graphically represent a target asset allocation and a current asset allocation for the portfolio. In particular, the target asset allocation data is represented using the bar 760 and the current asset allocation data is represented using the bar 770. The bars 760 and 770 illustrates the distribution of assets among three classes—“equities”, “fixed income”, and “cash and equivalents”. For example, in the bar 760 (and similarly for bar 770), each asset class is represented by a respective portion, and the size of the portion occupied by an asset class corresponds to a portfolio weight for that class. The bars 760 and 770 are located adjacent to each other, which facilitates a visual comparison of the allocation information.

The dashboard also includes a plurality of user interface elements 780a-c that correspond to actions which may be performed in connection with a portfolio associated with the resource account. The button 780a allows for re-balancing of the portfolio. Selecting the button 780a initiates a process for re-aligning the portfolio weights of the various asset classes with the target weights specified in a target allocation. In FIG. 7, the button 780a is shown as highlighted, which may be an indication that re-balancing of the portfolio is available. In particular, the visual appearance of the button 780a may be changed (e.g. shown in highlight, different color, etc.) to indicate that the portfolio may be re-balanced, i.e. the current asset allocation of the portfolio is different from the target allocation. A user selection of the button 780a may correspond to the second user input described in operation 408 of process 400. That is, selecting the button 780a may cause execution of a current set of proposed trade orders for the portfolio. Prior to initiating the re-balancing process, the user may wish to review the current set of proposed trade orders. For example, the user may review and modify (e.g. add, remove, change quantity, etc.) the proposed trade orders. The button 780c provides access to the trade order review functionality.

The button 780b may be used for updating a target allocation of the portfolio. A user may select the button 780b and input an updated definition of the target allocation. For example, the user may change the target weights associated with the asset classes in the portfolio. Once the target allocation is updated, the display of the bar 760 may also be updated to reflect the changes to the target allocation.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a communications module communicable with an external network;
a memory; and
a processor coupled to the communications module and the memory, the processor being configured to:
receive, via a client device, a first user input indicating a target allocation for one or more trading accounts, the target allocation identifying an allocation of tradeable objects in the one or more trading accounts;
generate a set of trade orders, wherein the generating includes:
comparing the target allocation to current holdings of tradeable objects in the one or more trading accounts to identify differences between the target allocation and the current holdings; and
generating one or more trade orders based on the identified differences, the trade orders intended to conform the holdings to the target allocation;
receive, via the client device, a second user input requesting a re-allocation of tradeable objects in the one or more trading accounts; and
in response to receiving the second user input, execute the set of trade orders, wherein the executing includes:
determining, for at least one of the trade orders, one or more respective preconditions associated with executing the trade order; and
executing the trade orders, wherein a given one of the trade orders is executed responsive to the associated preconditions being satisfied.

2. The computing system of claim 1, wherein determining, for at least one of the trade orders, a respective precondition associated with the trade order comprises determining an order of execution of the trade order.

3. The computing system of claim 1, wherein determining, for at least one of the trade orders, a respective precondition associated with the trade order comprises identifying one or more related trade orders that are required to be executed prior to the trade order.

4. The computing system of claim 3, wherein the processor is configured to determine, for at least one of the related trade orders, an associated timeout period, and wherein the trade order is executed only upon expiration of the associated timeout period for the at least one of the related trade orders.

5. The computing system of claim 1, wherein the processor is further configured to determine asset classes associated with the tradeable objects of the current holdings, and wherein identifying differences between the target allocation and the current holdings comprises determining differences for respective ones of the asset classes.

6. The computing system of claim 1, wherein the processor is further configured to:
determine one or more customized allocations based on the current holdings of tradeable objects in the one or more trading accounts; and
transmit, for display on the client device, the one or more customized allocations.

7. The computing system of claim 1, wherein generating the set of trade orders comprises:
identifying one or more tradeable objects indicated in the target allocation which are not included in the current holdings; and
generating buy orders corresponding to the identified tradeable objects.

8. The computing system of claim 1, wherein generating the set of trade orders comprises:
identifying one or more tradeable objects included in the current holdings which are not indicated in the target allocation; and
generating sell orders corresponding to the identified tradeable objects.

9. The computing system of claim 1, wherein the processor is further configured to:
detect that one or more of the trade orders cannot be executed as initially generated;
in response to the detecting, determine changes to the set of trade orders by identifying one or more additional trade orders; and
execute the one or more additional trade orders.

10. The computing system of claim 1, wherein the set of trade orders cannot be changed after execution of the trade orders begins.

11. A computer-implemented method, comprising:
receiving, via a client device, a first user input indicating a target allocation for one or more trading accounts, the target allocation identifying an allocation of tradeable objects in the one or more trading accounts;
generating a set of trade orders, wherein the generating includes:
comparing the target allocation to current holdings of tradeable objects in the one or more trading accounts to identify differences between the target allocation and the current holdings; and
generating one or more trade orders based on the identified differences, the trade orders intended to conform the holdings to the target allocation;
receiving, via the client device, a second user input requesting a re-allocation of tradeable objects in the one or more trading accounts; and
in response to receiving the second user input, execute the set of trade orders, wherein the executing includes:
determining, for at least one of the trade orders, one or more respective preconditions associated with executing the trade order; and
executing the trade orders, wherein a given one of the trade orders is executed responsive to the associated preconditions being satisfied.

12. The method of claim 11, wherein determining, for at least one of the trade orders, a respective precondition associated with the trade order comprises determining an order of execution of the trade order.

13. The method of claim 11, wherein determining, for at least one of the trade orders, a respective precondition associated with the trade order comprises identifying one or more related trade orders that are required to be executed prior to the trade order.

14. The method of claim 13, further comprising determining, for at least one of the related trade orders, an associated timeout period, wherein the trade order is executed only upon expiration of the associated timeout period for the at least one of the related trade orders.

15. The method of claim 11, further comprising determining asset classes associated with the tradeable objects of the current holdings, wherein identifying differences between the target allocation and the current holdings comprises determining differences for respective ones of the asset classes.

16. The method of claim 11, further comprising:
determining one or more customized allocations based on the current holdings of tradeable objects in the one or more trading accounts; and
transmitting, for display on the client device, the one or more customized allocations.

17. The method of claim 11, wherein generating the set of trade orders comprises:
identifying one or more tradeable objects indicated in the target allocation which are not included in the current holdings; and
generating buy orders corresponding to the identified tradeable objects.

18. The method of claim 11, wherein generating the set of trade orders comprises:
identifying one or more tradeable objects included in the current holdings which are not indicated in the target allocation; and
generating sell orders corresponding to the identified tradeable objects.

19. The method of claim 11, further comprising:
detecting that one or more of the trade orders cannot be executed as initially generated;
in response to the detecting, determining changes to the set of trade orders by identifying one or more additional trade orders; and
executing the one or more additional trade orders.

20. The method of claim 11, wherein the set of trade orders cannot be changed after execution of the trade orders begins.
